(19) United States
(12) Patent Application Publication
(10) Pub. No.: US 2007/0062978 A1
(43) Pub. Date: Mar. 22, 2007

(54) Piston for a cosmetic dispenser, cosmetic product dispenser and method for assembling said dispenser

(76) Inventors: Antoine Bruno, Rungis (FR); Michel Domy, Cran-Gevrier (FR); Gaetan Liberatore, Quintal (FR)

Correspondence Address: ST. ONGE STEWARD JOHNSTON & REENS, LLC, 986 BEDFORD STREET, STAMFORD, CT, 06905-5619, US

(21) Appl. No.: 11/521,096

(22) Filed: Sep. 14, 2006

Related U.S. Application Data
(63) Continuation of application No. PCT/FR05/00504, filed on Mar. 3, 2005.

(30) Foreign Application Priority Data
Mar. 17, 2004 (FR) 0402780

(51) Int. Cl. G01F 11/00

(52) U.S. Cl. 222/390

(57) ABSTRACT

The inventive cosmetic, hygienic or pharmaceutical product dispenser comprises a cylindrical head defining a geometrical axis, a product-containing volume, a threaded axial rod which is rotatably movable around the geometrical axis with respect to the head and a piston which consists of a piston body radially interacting with the cylindrical head, a first threaded part and a second threaded part, wherein the first threaded part is movable with respect to the piston body between a mounting position and an operating position. In the operating position, the first threaded part forms with the second threaded part an internal thread interacting with the threaded rod. In the mounting position, the first threaded part is positioned at a distance from the second threaded part, thereby enabling the threaded rod to be positioned with respect to the piston body in such a way that said first threaded part is not engageable therewith.

### CROSS-REFERENCE TO RELATED APPLICATIONS

The present application is a continuation of pending International patent application PCT/FR2005/000504 filed on Mar. 3, 2005 which designates the United States and claims priority from French patent application 0402780 filed on Mar. 17, 2004, the content of which is incorporated herein by reference.

### FIELD OF THE INVENTION

The invention relates to a dispenser for cosmetic, hygienic or pharmaceutical products with a piston.

### BACKGROUND OF THE INVENTION

There are known dispensers for cosmetic, hygienic or pharmaceutical products that comprise a piston sliding inside a cylinder head defining a volume in which the product is housed. The translation movement of the piston inside the cylinder head makes it possible to evacuate the product through a nozzle or an orifice at the end of the cylinder head. Different types of mechanisms can be implemented in order to drive the piston. In particular, it is possible to use a mechanism with a threaded rod, in contact with a threaded bore of the piston. However, the assembly of the piston on the threaded rod requires a screwing operation that becomes a restricting factor in the event of wanting to automate the assembly process. In addition, a part of the thread of the rod is only used during the assembly and becomes useless during subsequent use when dispensing the product.

The invention therefore aims to facilitate the assembly of a dispenser of cosmetic, hygienic or pharmaceutical products. More particularly, the invention aims to simplify the assembly of a dispenser of the type that uses a piston and a threaded rod and to reduce its cost.

### SUMMARY OF THE INVENTION

For this purpose, the invention relates to a piston for a dispenser of cosmetic, hygienic or pharmaceutical products, comprising:

a piston skirt defining a geometric axis;

a first threaded part comprising a first inner threaded sector, the first threaded part being mobile in relation to the piston skirt between an assembly position and an operational position; and

a second threaded part comprising a second inner threaded sector which, when the first threaded part is in the operational position, forms with the first threaded sector a resulting axial inner thread, the first threaded part in assembly position being positioned at a distance from the second threaded part.

In the assembly position, it is possible to position the piston with regard to a threaded rod intended to come into contact with the resulting inner thread without passing through a step of screwing the piston onto the threaded rod or with a reduced screwing step. When passing from the assembly position to the operational position, the first threaded part closes over the threaded rod and comes into contact with the latter. The resulting thread can be continuous and form a complete helix, or else it may consist of two sectors of the same helix, as long as the resulting thread enables the screwing of a threaded rod.

Any suitable means can be implemented to ensure the mobility of the first threaded part in relation to the piston skirt. It is possible, in particular, to resort to the use of deformable linking elements made as a single piece with the piston skirt and connecting the latter to the first threaded part. It is also possible to use a deformable linking element that connects the first threaded part to the second threaded part. The movement from the assembly position to the operational position preferably comprises a component of rotation about an axis of rotation which can be placed in any direction whatsoever in relation to the axis of the piston. According to a preferred embodiment of the invention, the first threaded part is connected to the piston skirt by means of a hinge that allows the first threaded part to pass from the assembly position to the operational position. In a particularly advantageous fashion, the piston skirt, the first threaded part, the second threaded part and the hinge make up a single piece made from a plastic material, the hinge comprising at least one deformable linking bracket. The deformation of the bracket can be elastic or otherwise.

The holding of the first threaded part in operational position can be provided by various means. It is possible, for example, to provide brackets of elastic staples or other means of blocking by deformation made as a single piece with the piston and making it possible to fix the first threaded part to the piston skirt and/or to the second threaded part. The blocking in operational position is preferably obtained by cooperation of the first threaded part with a part of the dispenser in which the piston is integrated. In particular, the first threaded part is equipped with a guide surface to cooperate with a cylindrical cylinder head of the dispenser such as to hold the first threaded part in operational position.

The second threaded part can be fixed in relation to the piston skirt. Alternatively, the second threaded part is mobile in relation to the piston skirt between an assembly position and an operational position, the second threaded sector forming, together with the first threaded sector, said resulting axial inner thread when the first threaded part and the second threaded part are in the operational position, the second threaded part in assembly position being situated at a distance from the first threaded part.

The piston skirt advantageously forms a closed tubular sheath and is equipped with a peripheral crown which sticks out radially from the tubular sheath. The sheath is capable of accommodating the threaded rod in such as way that the latter is not in contact with the product to be dispensed.

According to a second aspect of the invention, it relates to a dispenser of a cosmetic, hygienic or pharmaceutical product, comprising:

a cylindrical cylinder head, defining a geometric axis and a volume in which to house the product;

a threaded axial rod that is rotatingly mobile in relation to the cylinder head around the geometric axis; and

a piston comprising:

a piston skirt that is capable of cooperating radially with the cylindrical cylinder head;

a first threaded part comprising a first inner threaded sector, the first threaded part being mobile in relation to the piston skirt between an assembly position and an operational position;

a second threaded part comprising a second inner threaded sector which, when the first threaded part is in the operational position, forms with the first threaded sector a resulting inner thread that cooperates with the threaded rod, the first threaded part in assembly position being positioned at a distance from the second threaded part so that it is possible to position the threaded rod in relation to the piston skirt without the first threaded part being in contact with the threaded rod; and

means for guiding the axial translation of the piston in relation to the cylinder head so that, when the first threaded part is in the operational position and the threaded rod turns in relation to the cylinder head, the piston slides axially in relation to the cylinder head, the peripheral crown cooperating with the cylinder head to form a watertight seal for the product.

The piston has, as required, all or some of the previously described characteristics. In particular, it is advantageous to provide for the piston skirt to form a tubular sheath that can accommodate the threaded rod and separate the threaded rod from the volume in which the product is housed, and for it to be equipped with a peripheral crown that sticks out radially from the tubular sheath such as to cooperate with the cylinder head. It is also advantageous for the first threaded part in operational position and the second threaded part in operational position to be located on one axial side of the piston skirt that is opposite the volume in which the product is housed.

According to a third aspect of the invention, it also relates to a method of assembling a dispenser of a cosmetic, hygienic or pharmaceutical product equipped with a piston as described above, the method comprising:

a first step in which a threaded rod is placed between the first threaded part in assembly position and the second threaded part;

a second step in which the first threaded part is positioned in operational position so that the threaded rod is in contact with the first threaded sector and the second threaded sector.

The method advantageously also comprises a third step in which the piston is positioned in the cylinder head in such a manner that the piston skirt cooperates radially with the cylindrical cylinder head and the cylinder head holds the first threaded part in operational position.

According to a fourth aspect of the invention, it also relates to a method of assembling a dispenser of cosmetic, hygienic or pharmaceutical products equipped with a piston in which the second threaded part is mobile in relation to the piston skirt between an assembly position and an operational position, the second threaded sector forming with the first threaded sector said resulting axial inner thread when the first threaded part and the second threaded part are in operational position, the second threaded part in assembly position being situated at a distance from the first threaded part, the method comprising:
a first step in which a threaded rod is inserted in a translation movement between the first threaded part in assembly position and the second threaded part in assembly position;
a second step in which the first threaded part and the second threaded part are positioned in operating position, so that the threaded rod comes into contact with the first threaded sector and the second threaded sector.

The method advantageously also comprises a third step in which the piston is positioned in a cylinder head in such a manner that the piston skirt cooperates radially with the cylindrical cylinder head and the cylinder head holds the first threaded part and the second threaded part in operational position.

### BRIEF DESCRIPTION OF THE DRAWINGS

Further advantages and characteristics will appear more clearly from the following description of a specific embodiment of the invention, provided as a non-exhaustive example, and represented in the appended drawings, in which:

FIG. 1 shows a perspective view of a piston according to the invention, equipped with threaded parts shown in their assembly position;

FIG. 2 shows the piston of FIG. 1, the threaded parts being in their operational position;

FIGS. 3A to 3G show various consecutive steps of a method of assembling a dispenser of a cosmetic, hygienic or pharmaceutical product comprising the piston of FIG. 1.

### DETAILED DESCRIPTION OF THE INVENTION

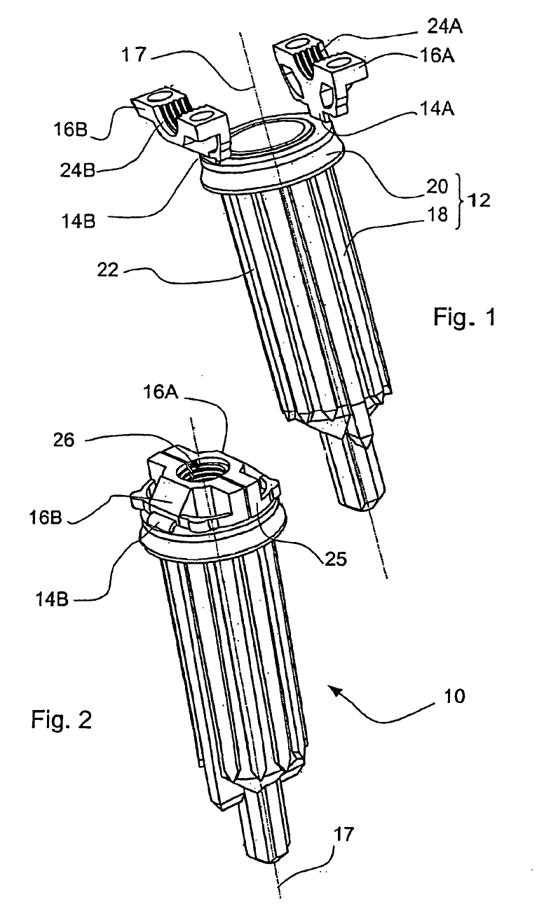

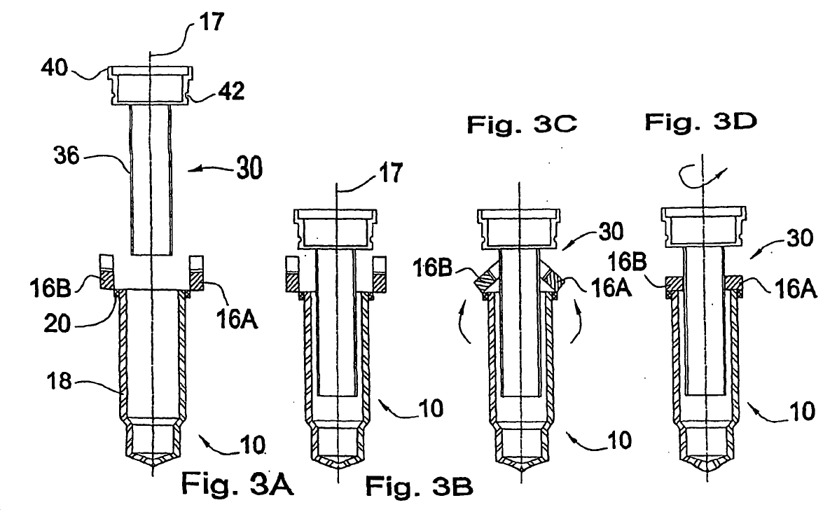

In reference to FIGS. 1 and 2, a single-piece piston made from a plastic material 10 obtained by injection moulding is made up of a piston skirt 12 connected by deformable linking brackets 14A, 14B to two threaded parts 16A, 16B.

The piston skirt 12, which defines a geometric axis of reference 17 comprises a tubular sheath 18 that is closed at one end and a peripheral crown 20 that sticks out radially from the tubular sheath 18. The threaded parts 16A, 16B and the sheath 18 are located axially on either side of the peripheral crown 20. The sheath 18 is equipped with one or several ribs 22 that project radially and extend axially along all or part of the length of the sheath.

The deformable linking brackets 14A, 14B constitute hinges that allow the threaded parts 16A, 16B to be folded between an assembly position shown in FIG. 1 and an operational position shown in FIG. 2. The threaded parts 16A, 16B are equipped with radial guide surfaces 25 as well as with complementary threaded sectors 22A, 22B which, in operational position, form a continuous transversal axial thread 26.

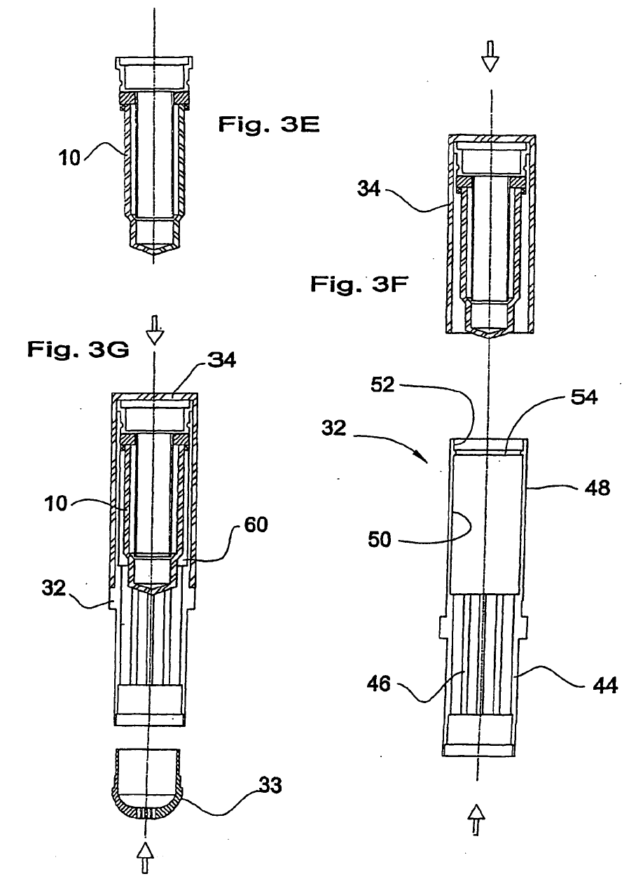

FIGS. 3A to 3D show the steps in a method of assembling a dispenser of a cosmetic, hygienic or pharmaceutical product comprising the single-piece piston of FIG. 1.

The dispenser comprises (in FIG. 3G), in addition to the single-piece piston, a threaded rod 30, a tubular sheath 32 sealed off by a nozzle 33 equipped with an orifice for expelling the product and a cover 34.

The threaded rod 30 is equipped with a thread 36 and a flared head 40 comprising a radial circular groove 42. The cylinder head 32 comprises a lower part 44 equipped with at least one groove 46 designed so as to cooperate with the rib 22 of the single-piece piston and an upper part 48 forming a cylindrical inner wall 50 to ensure the sliding of the piston 10. This cylindrical wall 50 is extended by a thinner end part 52 equipped with a circular strip 54 that projects radially towards the inside of the diameter of the cylindrical wall, to cooperate with the radial circular groove 42 of the head 40 of the threaded rod.

Initially, the threaded rod 30 is presented in the axis 17 of the sheath, the threaded parts 16A, 16B being in assembly position (FIG. 3A). The threaded rod 30 is inserted in the sheath 18 by simple translation according to the axis 17 (FIG. 3B), then the threaded parts 16A, 16B are folded (FIG. 3C) so that the threaded sectors 22A, 22B come into contact with the thread 36 of the threaded rod (FIG. 3D). It is then possible, if necessary, to perfect the positioning of the threaded rod by screwing it into the thread 26 of the piston until the head 40 of the threaded rod comes to a stop against the piston 10 (FIG. 3E), which also makes it possible to hold the threaded parts 16A, 16B in operational position in the subsequent steps of the assembly of the dispenser.

Next, the cover 34 is inserted over the flared part 40 of the threaded rod, so that the threaded rod 30 and the cover 34 become solidly attached in rotation and in translation (FIG. 3F). The subassembly made up of the threaded rod 30, the cover 34 and the piston 10 constitutes a mechanism that is then mounted on the cylinder head 32 (FIG. 3G), so that the end strip 54 of the cylinder head enters the circular groove 42 of the head, preventing any translation movement between the two subassemblies, but allowing relative rotation movements. The peripheral crown 20 of the piston is then in contact with the cylindrical wall 50 of the cylinder head, ensuring the watertightness of the product. Furthermore, the guide surfaces 25 cooperate with the cylindrical wall 50 to prevent the threaded parts 16A, 16B from leaving their operational position. The volume 60 can then be filled with the product to be dispensed, before inserting the nozzle 33. The volume located between the piston 10 and the free end of the cylinder head 32 constitutes a volume 60 for housing the product, which can be filled before sealing the free end of the cylinder head with the nozzle equipped with the orifice for expelling the product.

In order to operate the mechanism, simply turn the cover 34 in relation to the cylinder head 32. The cover 34 drives the threaded rod 30 to which it is solidly attached. The piston 10, whose rib 22 is lodged in the groove 46 of the cylinder head, cannot turn. The efforts exerted by the threaded rod 30 on the thread 26 of the piston therefore impose a translation movement of the piston 10 in relation to the rod 30 and the cylinder head 32, and the product is expelled through the orifice of the nozzle 33.

Several modifications are obviously possible.

The same principle of assembling the piston on the threaded rod can be used for a dispenser mechanism for solid or thick products such as, for example, lipstick. In this case, the piston does not need to ensure the watertightness between the volume that houses the product and the mechanism, but exerts a function of supporting the solid product and of guiding it in relation to the walls of the cylinder head.

The cover does not necessarily cover the cylinder head. The threaded rod can be guided in rotation around its axis and fixed in translation in relation to the cylinder head by any suitable means. Likewise, the translation guide between the piston and the cylinder head, which prevents the rotation of the piston in relation to the cylinder head, can be provided by any means. In particular, the piston and the cylinder head can have a non-circular cross-section, so that the rib and groove guide can be eliminated, if required.

The sheath of the piston, which provides a separation between the product and the threaded rod, can be eliminated if the product is solid or if it is possible to provide sufficient watertightness with the thread alone. This is the case particularly when the product has considerable viscosity or consists of a powder with a sufficiently thick grain.

In the embodiment of the invention shown, the two threaded parts are joined together following an axial plane. However, the mating surface of the two threaded parts can be different, for example following two axial semi-planes delimiting an angular sector. Moreover, the thread 26 made up of the threaded sectors 22A, 22B can be incomplete and, on the contrary, formed by two opposing threaded sectors, as long as the resulting thread effectively enables cooperation with the outer thread of the rod.

1. Piston for a dispenser of cosmetic, hygienic or pharmaceutical products, comprising:
a piston skirt defining a geometric axis;
a first threaded part comprising a first inner threaded sector, the first threaded part being mobile in relation to the piston skirt between an assembly position and an operational position; and
a second threaded part comprising a second inner threaded sector which, when the first threaded part is in the operational position, forms with the first threaded sector a resulting axial inner thread, the first threaded part in assembly position being positioned at a distance from the second threaded part, characterised in that the piston skirt forms a closed tubular sheath and is equipped with a peripheral crown which sticks out radially from the tubular sheath.

2. Piston according to claim 1, in which the first threaded part is connected to the piston skirt by a hinge that allows the first threaded part to pass from the assembly position to the operational position.

3. Piston according to claim 2, in which the piston skirt, the first threaded part, the second threaded part and the hinge make up a single piece made from a plastic material, the hinge comprising at least one deformable linking bracket.

4. Piston according to claim 1, in which the first threaded part is equipped with a guide surface to cooperate with a cylindrical cylinder head of the dispenser in order to hold the first threaded part in the operational position.

5. Piston according to claim 1, in which the second threaded part is mobile in relation to the piston skirt between an assembly position and an operational position, the second threaded sector forming with the first threaded sector said resulting axial inner thread when the first threaded part and the second threaded part are in operational position, the second threaded part in assembly position being located at a distance from the first threaded part.

6. Dispenser of cosmetic, hygienic or pharmaceutical products, comprising:
a cylindrical cylinder head, defining a geometric axis and a volume in which to house the product;
a threaded axial rod that is rotatingly mobile in relation to the cylinder head around the geometric axis; and
a piston comprising:
a piston skirt that is capable of cooperating radially with the cylindrical cylinder head and forming a tubular sheath in which the threaded rod is housed, separated from the volume that houses the product;
a first threaded part comprising a first inner threaded sector, the first threaded part being mobile in relation to the piston skirt between an assembly position and an operational position;
a second threaded part comprising a second inner threaded sector which, when the first threaded part is in the operational position, forms with the first threaded sector a resulting axial inner thread that cooperates with the threaded rod, the first threaded part in assembly position being positioned at a distance from the second threaded part so that it is possible to position the threaded rod in relation to the piston skirt without the first threaded part being in contact with the threaded rod; and
means for guiding the axial translation of the piston in relation to the cylinder head so that, when the first threaded part is in the operational position and the threaded rod turns in relation to the cylinder head, the piston slides axially in relation to the cylinder head, the peripheral crown cooperating with the cylinder head to form a watertight seal for the product.

7. Dispenser according to claim 6, in which the first threaded part is connected to the piston skirt by a hinge that allows the first threaded part to pass from its assembly position to its operational position.

8. Dispenser according to claim 7, in which the piston skirt, the first threaded part, the second threaded part and the hinge make up a single piece made from a plastic material, the hinge comprising at least one deformable linking bracket.

9. Dispenser according to any claim 6, in which the first threaded part is equipped with a guide surface for cooperating with a cylindrical cylinder head of the dispenser in order to hold the first threaded part in operational position.

10. Dispenser according to claim 6, in which the second threaded part is mobile in relation to the piston skirt between an assembly position and an operational position, the second threaded sector forming with the first threaded sector said resulting axial inner thread when the first threaded part and the second threaded part are in operational position, the second threaded part in assembly position being located at a distance from the first threaded part.

11. Dispenser according to claim 6, in which the piston skirt is equipped with a peripheral crown that sticks out radially from the tubular sheath to cooperate with the cylinder head.

12. Dispenser according to claim 6, in which the first threaded part in operational position and the second threaded part in operational position are located on one axial side of the piston skirt that is opposite the volume in which the product is housed.

13. Method of assembling a dispenser of cosmetic, hygienic or pharmaceutical products equipped with a piston according to claim 1, the method comprising:
a first step in which a threaded rod is placed between the first threaded part in assembly position and the second threaded part;
a second step in which the first threaded part is positioned in operational position so that the threaded rod is in contact with the first threaded sector and the second threaded sector.

14. Method according to claim 13, also comprising a third step in which the piston is positioned in a cylinder head in such a manner that the piston skirt cooperates radially with the cylindrical cylinder head and the cylinder head holds the first threaded part in operational position.

15. Method of assembling a dispenser of cosmetic, hygienic or pharmaceutical products equipped with a piston according to claim 5, the method comprising:
a first step in which a threaded rod is inserted in a translation movement between the first threaded part in assembly position and the second threaded part in assembly position;
a second step in which the first threaded part and the second threaded part are positioned in operating position, so that the threaded rod comes into contact with the first threaded sector and the second threaded sector.

16. Method according to claim 15, also comprising a third step in which the piston is positioned in a cylinder head in such a manner that the piston skirt cooperates radially with the cylindrical cylinder head and the cylinder head holds the first threaded part and the second threaded part in operational position.
